(19) United States
(12) Patent Application Publication
(10) Pub. No.: US 2016/0356307 A1
(43) Pub. Date: Dec. 8, 2016

(54) Carbon Composite Piston Engine Crankshaft

(71) Applicant: James Walter Linck, San Diego, CA (US)

(72) Inventor: James Walter Linck, San Diego, CA (US)

(21) Appl. No.: 15/149,164

(22) Filed: May 8, 2016

Related U.S. Application Data
(60) Provisional application No. 62/159,266, filed on May 9, 2015.

(51) Int. Cl. F16C 3/10; B29C 70/34

(52) U.S. Cl. CPC F16C 3/10; B29C 70/342; B29K 2063/00

(57) ABSTRACT

A piston engine crankshaft made from carbon composite molded in two separate moldings is disclosed. According to a preferred embodiment, the first mold takes the top dead center piston ignition load. The second molding takes the dynamic piston and rod load and contains the counterweight. Accordingly, carbon fiber filaments are aligned in preferred directions to optimally absorb loads at different areas of the crankshaft.

### PRIORITY CLAIM

This patent application claims benefit of the priority date of U.S. Prov. Pat. App. Ser. No. 62/159,266 filed on May 9, 2015 entitled “Carbon Composite Piston Engine Crankshaft;” accordingly, the entire contents of this patent submission is hereby expressly incorporated by reference.

### BACKGROUND OF THE INVENTION

Field of the Invention

The present invention pertains generally to crankshafts that mechanically convert reciprocating motion to rotational motion, for example in a train, automobile, or aircraft. More specifically, in a preferred embodiment, the invention relates a carbon composite crankshaft for a piston engine made from two separate molds.

Description of the Prior Art

Heretofore, crankshafts have been known coupled to a piston cylinder arrangement via a connecting rod. Further configured to the crankshaft are journal bearings that flank the rotating connection between the rod and crankshaft. Importantly, particularly at high revolutions per minute (RPM) on the order of 3×1,000 to 5×1,000, the crankshaft will undergo complex loading to include bending and flexing as well as centrifugal stresses.

Also notable, metal crankshafts are relatively heavy and typically made from a single body cast repeatedly forged into shape for maximum structural integrity. Since metal material such as steel has crystalline lattice structure, loads are not optimized for any particular direction. Composites, on the other hand, are vastly different wherein material layers form a lay-up. Hence, a filament can absorb structural loads only in a direction of the filament. And, lay-ups should have filaments aligned in every direction corresponding to loads which makes the fabrication process very complex.

An illustrative example of composite loading is the airplane wing. Therein, loads are received similar to an I-beam structure in that filaments on top are all in compression (toward the direction of bending stress) and the filaments on the bottom are all in tension. The filaments in the middle are all in shear. The crankshaft presents a complex problem because it's not static loaded like the airplane wing, rather instead; loads result from spinning and counter balanced rotational motion that are very dynamic. Therefore it is an object of the present invention to address multiple dynamic loading to different areas of the crankshaft. The present solution takes the spinning structural loads in one molding, then takes the counter balance load in another molding.

Further in the present global energy objective, fuel economy is paramount and market prices for petroleum based fuels are complex. Therefore, the present invention seeks to provide technologies that reduce engine load under its own weight, potentially having a profound commercial impact.

An additional parameter in crankshaft design is temperature performance. Since components made from carbon composite begin to lose strength at a much lower 180 degrees Fahrenheit as compared to steel crankshafts which maintain performance at much higher temperatures.

In light of the above, it is an object of the present invention to provide a lightweight crankshaft wherein different parts are integrally optimized to receive differently types of loads. Still further it is an object of the present invention to provide cooling solution for a composite crankshaft.

### BRIEF SUMMARY OF THE INVENTION

The present invention specifically addresses and alleviates the above mentioned deficiencies, more specifically, the present invention in a first aspect is a carbon composite crankshaft for piston engines made from a process comprising two separate moldings wherein a first mold aligns carbon fiber filaments in a directly substantially parallel to an axis or rotation of the crankshaft and wherein a second mold aligns carbon fiber filaments in substantially all directions.

In a second closely related aspect, the invention is a carbon composite crankshaft, made from a process comprising the steps of molding a main shaft portion with a 1^{st} mold: laying up a multiplicity of carbon composite filaments substantially along an axis parallel to the main shaft in the first mold; and molding a counterweight portion with a 2^{nd} mold wherein carbon composite filaments are arranged substantially in a direction of stresses to the counterweight.

The invention in this aspect is additionally characterized wherein the molding a counterweight portion with a 2^{nd} mold wherein carbon composite filaments are arranged substantially in a direction of stresses to the counterweight is more specifically defined as a direction substantially perpendicular to the multiplicity of carbon composite filaments substantially along an axis parallel to the main shaft in the first mold. Alternatively, 2^{nd} mold is used to align carbon fiber filaments substantially in all directions.

Also in this aspect the invention is characterized as including the bonding the counterweight portion to the main shaft portion using a series of carbon filaments and a resin such as an epoxy.

While the apparatus and method has or will be described for the sake of grammatical fluidity with functional explanations, it is to be expressly understood that the claims, unless expressly formulated under 35 USC §112, or similar applicable law, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC §112 are to be accorded full statutory equivalents under 35 USC §112, or similar applicable law. The invention can be better visualized by turning now to the following drawings wherein like elements are referenced by like numerals.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic side view of one half of a preferred crankshaft for a one cylinder or multi-cylinder engine;

FIG. 2 is an additional side view of a first mold cavity for the piston loading portion of the crankshaft; and

FIG. 3 is illustrative of a second mold cavity that comprises the piston and rod counterweight as adhered to the crankshaft.

### DESCRIPTION OF PREFERRED EMBODIMENTS

The invention in a first aspect is a carbon composite piston engine crankshaft 10 made in two separate moldings (FIG. 2 and FIG. 3). The first molding takes the piston ignition loading. In other words, the stress the expanding cylinder imparts on the crankshaft at top dead center. The second molding takes the piston and rod dynamic loading and contains their counterweight. The mold material carrying complex loading is a typical high modulus material which can be made in many ways. The bearing and lubrication requirements of the carbon composite crankshaft 10 are similar to steel crankshafts.

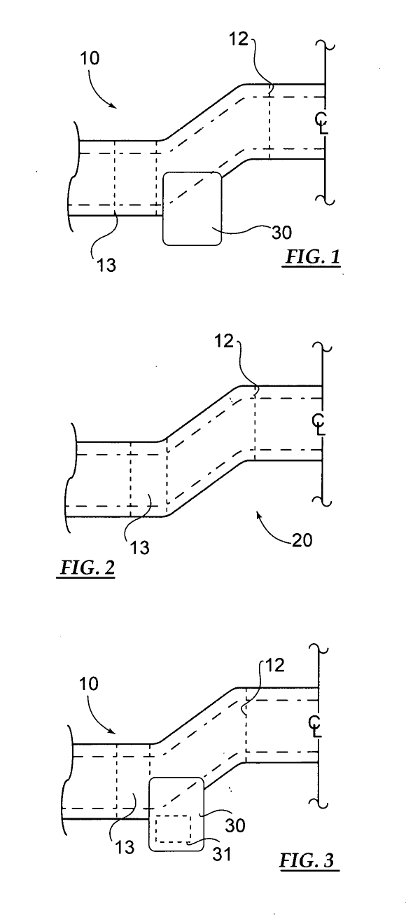

With regard to FIG. 1, a carbon composite crankshaft 10 is shown for piston engines, made from a process comprising the steps of molding a crankshaft from a first mold; molding a counterweight from a second mold; and bonding the counterweight to crankshaft. The invention in this aspect is additionally characterized as aligning (or laying-up) a plurality of carbon matrix filaments in a longitudinal direction with respect to the crankshaft. A second mold has a unique lay-up optimized for centrifugal loads as these loads are more problematic than the piston loads at 5,000 rpm. The counterweight made from the second mold is then bonded to the main shaft with a matrix having long filaments that wrap around the first lay-up main shaft.

Also with regard to FIG. 1, a side view of one-half of an exemplary crankshaft 10 is shown about a center line (CL). FIG. 2 illustrates a first molding 20 designed to absorb piston loads without brittle fracture. Rod bearing 12 and crankshaft bearing 13 are further integrated to this mold. Importantly in the process, an inflatable bladder is inserted into a mold cavity and thereby forming a crankshaft having hollow portions further reducing weight thereof without sacrificing strength. Interior side walls are illustrated with dashed lines outlining a hollow interior.

FIG. 3 illustrates a second molding for making a piston and rod counterweight 30. The second mold allows for material fibers having high modulus to be loaded in a different geometry, or lay-up, or filament density, optimized for its different loading as compared to the shaft piston loading. A heavy inert material 31 is inserted to the counterweight 30 mold in the molding process. Still further, inert material 31 may be recycled after useful engine life.

In still an additional embodiment, the invention is a carbon composite crankshaft 10 that is oil cooled with forced convention using two different oil pumps. As stated, the carbon composite will peak in structural performance at 180 degrees and rapidly decline at even higher temperatures. Ideally, the crankshaft 10 is maintained at just over 150 degrees which is problematic since the oil coming off the combustion chamber area is much hotter.

Also of concern, piston engines with one oil pump are often over used. This is because the engine is able to spin past peak load so the pump is set at the higher load. But however, a vehicle piston engine will typically operate primarily under peak. Hence according to the invention, two oil lubrication and cooling pumps are provided wherein a first is run at or under peak and the second pump supplements after peak, which facilitates engine longevity and wear. Also according to this embodiment, the first pump is configured to begin lubrication just before start-up which provides pre-oil to the engine particularly increasing its lifetime. Therefore further, the invention comprises an engine oil system having two pumps configured with a separator that keeps the top oil and crankcase separated until they enter the oil cooler.

It should be understood, of course, that the foregoing relates to exemplary embodiments of the invention and that modifications may be made without departing from the spirit and scope of the invention as set forth in the following claims.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

While the particular Carbon Composite Piston Crankshaft herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

I claim:

1. A carbon composite crankshaft for piston engines made from a process comprising two separate moldings wherein a first mold aligns carbon fiber filaments in a directly substantially parallel to an axis or rotation of the crankshaft and wherein a second mold aligns carbon fiber filaments in substantially all directions.

2. A carbon composite crankshaft, made from a process comprising:
molding a main shaft portion with a 1^{st} mold:
laying up a multiplicity of carbon composite filaments substantially along an axis parallel to the main shaft in the first mold; and
molding a counterweight portion with a 2^{nd} mold wherein carbon composite filaments are arranged substantially in a direction of stresses to the counterweight.

3. The carbon composite crankshaft, made from the process of claim 2 wherein the molding a counterweight portion with a 2^{nd} mold wherein carbon composite filaments are arranged substantially in a direction of stresses to the counterweight comprises a direction further substantially perpendicular to the multiplicity of carbon composite filaments substantially along an axis parallel to the main shaft in the first mold.

4. The carbon composite crankshaft, made from the process of claim 2 wherein the molding a counterweight portion with a 2^{nd} mold comprises aligning carbon fiber filaments substantially in all directions.

5. The carbon composite crankshaft, made from a process of claim 2 further comprising bonding the counterweight portion to the main shaft portion using a series of carbon filaments and a resin such as an epoxy.
